(19) United States
(12) Patent Application Publication
(10) Pub. No.: US 2010/0091312 A1
(43) Pub. Date: Apr. 15, 2010

(54) SMART COPY FUNCTION ENHANCEMENTS

(76) Inventors: Mark Joseph Edwards, Lexington, KY (US); Ricky Earl Robbins, Danville, KY (US); Ronald Todd Sellers, Stamping Ground, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/250,004

(22) Filed: Oct. 13, 2008

(51) Int. Cl. G06F 3/12

(52) U.S. Cl. 358/1.13

(57) ABSTRACT

Multiple enhancements are provided to a smart copy function of an imaging device to improve performance by making it operate in a time efficient manner. The enhancements include determining pre-positioning of the scan bar based upon the content type setting in the user interface. The smart copy function is also enhanced by determining when to implement and implementing a second pre-scan at a higher resolution when misidentification occurs. Another enhancement uses original size and edge to edge properties to determine content of the original document, which then allows optimal selection of the final copy scan and print parameters.

### CROSS REFERENCES TO RELATED APPLICATIONS

None

### STATEMENT REGARDING FEDERALLY SPONSORED RESEARCH OR DEVELOPMENT

None.

### REFERENCE TO SEQUENCE LISTING, ETC.

None.

### BACKGROUND

1. Field of Invention

The present disclosure relates generally to an enhancement of a smart copy function. A smart copy function as currently used and defined pre-scans an original document for copying at a reduced resolution to determine its content type and color qualities, adjusts the print and/or scan settings based on that determination, then scans the original document at an optimal scan resolution and prints it with optimal print settings. The present disclosure relates to improvements or enhancements to the smart copy function, for instance to make smart function pre-scans more time efficient, or to make smart copies more accurate.

2. Description of the Related Art

Smart copying fully pre-scans the document at reduced resolution. This pre-scan is used to determine the document image's content type and color qualities. After the content is identified, the document is rescanned at the optimal resolution and printed using the preferred print settings for the content and color quality determined to be in the original. This method is notably incorporated into combined scanners/printers often referred to as “all-in-one” devices. The intent of the smart copy function is to simplify the copy process for the user, as it reduces the number of copy settings they must decide; and resulting copy output quality is intended to be improved.

While smart copying improves the quality of copies by establishing optimum scan and print parameters on an individual basis, the full pre-scan costs additional time for the user. Each document is scanned twice, once for the full pre-scan and once for the full final scan. As such, there is a need for a more efficient method of determining the content type of documents.

### SUMMARY OF THE INVENTION

The present invention provides multiple enhancements to a smart copy function to improve performance, including making it operate in a time efficient manner. The enhancements include determining pre-positioning of the scan bar based upon the content type setting in a user Interface (UI) such as by way of non-limiting illustrative example in a GUI (Graphical User Interface, typically screens on a display on the operator panel) or in a TUI (Text User Interface). The present disclosure also provides for enhancing the smart copy function by determining when to implement and implementing a second pre-scan at a higher resolution when uncertainty in identification occurs. Another enhancement of the smart copy function provided by the present disclosure is using size of the color gamut and physical properties of the original document (an example is edge to edge, E2E) to aid in the determination of the content of the original.

### BRIEF DESCRIPTION OF THE DRAWINGS

Having thus described the invention in general terms, reference will now be made to the accompanying drawings, which are not necessarily drawn to scale, and wherein:

FIG. 1 is a top view of a scanner incorporating the present invention;

FIG. 2 is a diagram of the method of an exemplary embodiment of improved smart scanning;

FIG. 3 is a state diagram of the states for determining the position of the scan bar illustrating enhancement of the Smart Copy function in accordance with the present disclosure;

FIG. 4 is a flow chart illustrating how content type is examined to determine the pre scan resolution in illustrating enhancement of the smart copy function in accordance with the present disclosure; and

FIG. 5 is a flow chart illustrating another enhancement of the smart copy function where a determination is made for size and for adjusting color threshold for the gamut in accordance with the present disclosure.

### DETAILED DESCRIPTION

The present disclosure now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

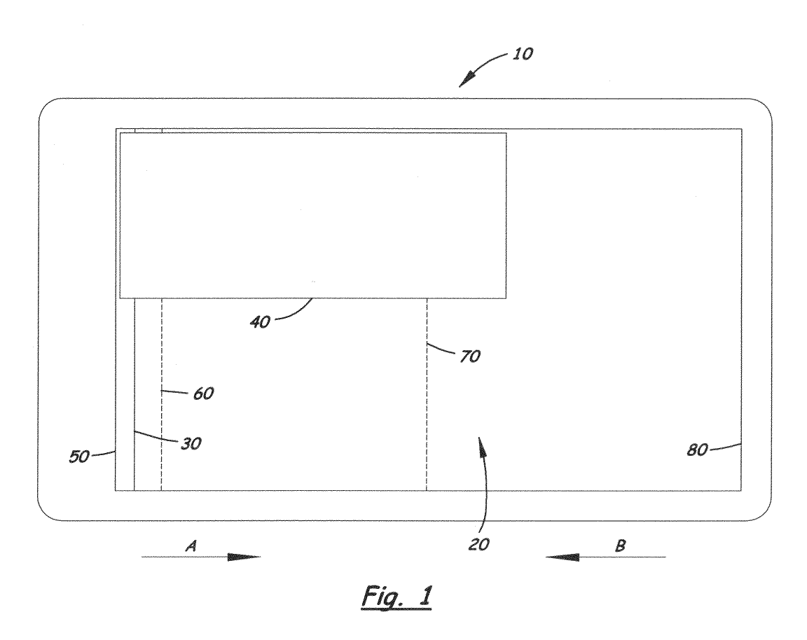

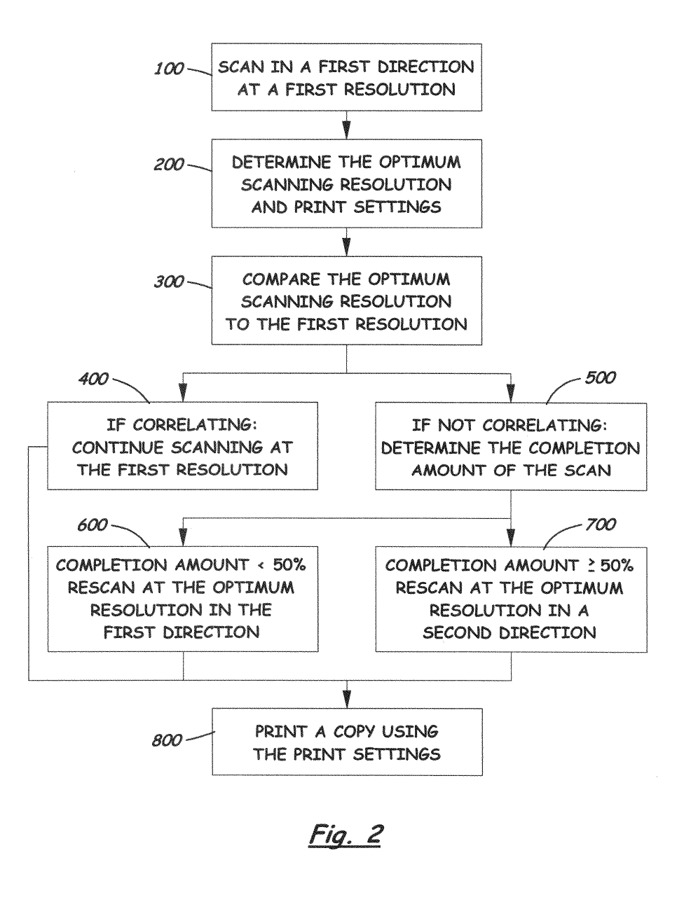

Referring to FIGS. 1 and 2, which are similar to corresponding figures in U.S. Ser. No. 11/850,958 that is assigned to the same assignee as the present invention and incorporated by reference herein in its entirety, there is shown an imaging system 1 having enhanced smart copy functionality, FIG. 1 illustrates an overhead view of a scanner of imaging system 1. The scanner 10 includes a scanner area 20 and a scan bar 30. A document 40 to be scanned is selected by the user. The document 40 can vary in properties from a simple black and white text document to a full color-picture. The document 40 is placed on the scanning area 20 so that the scan bar 30 can move across the scanning area 20 to scan the document 40. The scan bar 30 typically initiates from a first end of the scanner 50. The scan bar 30 then progresses in a first direction A from the first end of the scanner 50 to the second end of the scanner 80. After completing its first pass, the scan bar 30 returns to the first end of the scanner 50 in a second direction B. A copy of the document is then printed from a printer. The printer can either be a part of the scanner, commonly referred to as an all-in-one arrangement, or separate from the scanner.

It is understood that imaging system 1 may include other components, mechanisms and modules commonly found in imaging devices. For instance, imaging system 1 may include a print engine (not shown) for applying marks to a document; a UI for communicating information with a user; and an autodocument feed (ADF) mechanism (not shown) for imparting motion to media relative to scanner 10. It is further understood that scanner 10 may include a motor or the like and associated electronics (not shown) for imparting motion to scan bar 30 during a scan operation relative to the media being scanned.

One exemplary method of the present invention is illustrated in FIG. 2. The document is scanned in a first direction at a first resolution in step 100. The first resolution is typically a low or nominal resolution to increase the scanning speed and decrease time. A nominal resolution is typically a resolution between a low resolution, which may be used for basic black and white documents, and a high resolution, which may be preferred for photos with a large color gamut. For today's scanners, a nominal resolution is typically around 300 dpi (dot per inch) and a high resolution is typically around 600 dpi. As appreciated in the art, the specific resolutions referred to as low, nominal and high may change as improvements are made to scanner and printer technology. Additionally, those skilled in the art appreciate that resolution may be defined in various terms and still embody the spirit of the invention. Such resolution terms include, but are not limited to, pixels per inch, dots per inch and samples per inch.

The optimum scanning resolution and print settings are determined from the first scan in step 200. The optimum scanning resolution and print settings depend on the content of the document and the user's input. For example, whether the document is black and white, grayscale or color and whether the color gamut is large or small may influence the optimum scanning resolution and print settings. Furthermore, a user may request a high quality copy or low quality copy, and this may affect the optimum resolution or print settings. Depending on the specific scanner and printer, other properties may also be determined and used in selecting the optimum scanning resolution and print settings.

One exemplary embodiment of the present invention, illustrated in FIG. 1, limits the act of scanning at a first resolution to travel only a limited portion 60 of the scanning area 20, before the optimum scanning resolution and print settings are determined. A smart copy can often determine document properties with only a limited section of a document. For example, a smart copy can typically quickly discriminate the color gamut present in a picture, as compared to a black and white document, without traversing the document's entire length Therefore, the portion of the document to be initially scanned may be very small and still embody the spirit of the invention. Predetermined initial scanning lengths can range from a small portion of the document to a large portion of the document and still be effective at determining the content type.

In reference to FIG. 2, the determined optimum scanning resolution is then compared to the first scanning resolution at step 300. If the first scanning resolution correlates to the optimum resolution, then the scan continues in the first direction at the first resolution at step 400. Some variation between the first resolution and the optimum resolution may still be considered as correlating. For example, a range of resolutions that are considered correlating may be set on the scanner during manufacturing. In the alternative, a user may specify the range of resolutions acceptable to be considered as correlating. In the latter, the range may be influenced by the quality of print the user desires.

If the first resolution does not correlate with the optimum resolution, the document is rescanned at the optimum resolution. In an exemplary embodiment, the completion amount of the scanner is determined at step 500. If the completion is less than some predetermined threshold (in one exemplary embodiment 50%), the scan bar will return to its original starting position and rescan the document in first direction at step 600. However, if the completion is greater than or equal to the predetermined threshold, the scanner will rescan the document in a second, different direction at step 700. As seen in FIG. 1, the critical completion amount 70 is between the first end of the scanner 50 and the second end of the scanner 80. While the predetermined threshold of 50% is an exemplary embodiment, other completion amounts may be utilized to adjust for the individual scanner characteristics. In another embodiment, a user can vary the predetermined threshold through one or more user selections.

Typically, the scanner aborts the prescan and continues to the other end of the document so the document can be scanned in the other direction. This reduces the distance the scan bar must travel before rescanning at the optimum resolution. Depending on the actual scanner, the target completion percentage may change. For instance, it may be more efficient to scan in a second direction even at a completion percentage lower than the predetermined threshold to avoid stopping and reversing the scan bar on its first pass.

Once the document is scanned at the optimum resolution or the first resolution if the first resolution correlates to the optimum resolution, a copy of the document is printed using the print settings at step 800. In one exemplary embodiment, the printing process initiates before the scan completes to decrease the overall time between scanning and printing. Once the print settings are known, the printer can prepare accordingly without waiting for the final scan to complete. The printer may also start printing the copy while the scan bar is still completing its final pass.

Another exemplary embodiment of the present invention is a computer readable medium having a computer program embodied thereon, the computer program being executable by a machine to scan a document and print a copy. The machine, according to the present exemplary embodiment of the present invention, may execute the acts of scanning the document with a first resolution, determining a content type of the scanned document while scanning at the first resolution and determining an optimum scanning resolution based on the content type. The machine further executes the acts of rescanning the document at the optimum resolution if the first resolution does not correlate with the optimum resolution, selecting a print setting based on the content type and printing the copy using the print setting.

The smart copy function pre-scans an original document at reduced resolution to determine the original document's content type and color qualities and to adjust the print and/or scan settings from this determination and then rescans the document at an optimal scan resolution and prints it. While typically the prior art smart copy function provides for an improved output quality and an improved performance because of its optimized scan area selection and scan resolution selection, there are two areas in which the current smart copy function is not 100% efficient.

One area is the scan bar position before copying the original document. In the typical smart copy embodiment, the original document is pre-scanned from the bottom of the page to the top of the page, then final scanned from top of page to bottom, and the scan bar then remains at the bottom of page position to be ready for the next smart copy. When smart copying is ‘turned off’, non-smart copies or host copies park the scan bar at the top of the page to be ready for the next non-smart copy. If the scan bar is not in the optimum position for an upcoming copy or scan operation, there is a time penalty for the user when a copy or scan operation is launched while the scan bar moves to the correct start position.

The second area is consistently determining the exact content type of the original document. The smart copy function may have difficulty determining a single correct content type of the original document across all originals. There are occasions when the resulting identification borders on, for instance, two possible content types. This situation herein is termed as misidentification In some cases, if the correct content type is not determined, a sub-optimal copy might be performed. The prior art smart copy function uses only the image data collected and fixed thresholds to determine the content type of the originals.

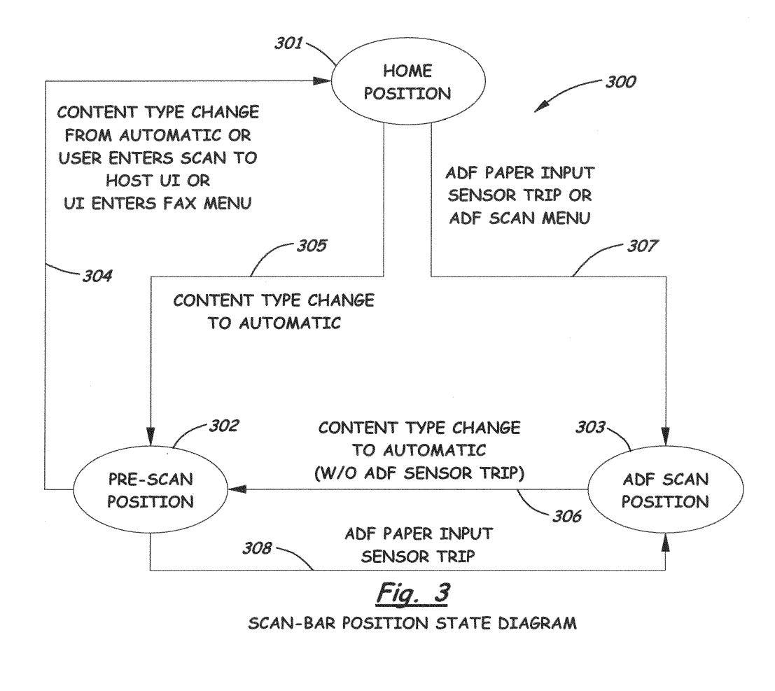

FIG. 3 addresses the first area of concern by illustrating an enhancement to the smart copy function provided by this invention. FIG. 3 shows a flow chart illustrating the various states that determine where the scan bar can be positioned. This enhancement reduces time penalties of non-optimally parking the scan bar. It also improves the acoustic performance during the smart copy positioning of the scan bar. This embodiment of the present disclosure provides for pre-positioning the scan bar to its correct location upon detecting an indication that a copy or scan is upcoming.

In FIG. 3, the state diagram 300 has several states: a Home Position state 301; a Pre-scan Position state 302; and an ADF Scan Position state 303. These three states 301, 302 and 303 indicate three possible positions for the scan bar to be parked awaiting an operation. In the Home Position state 301 the scan bar is positioned at the top of the page. In the Pre-scan Position 302 state the scan bar is positioned at the bottom of the page. In the ADF Scan state 303 the scan bar is typically positioned at a location above that of the Home State position in a letter box window above the top of the page. FIG. 3 illustrates the factors that determine which state and thus where the scan bar will be positioned. As can be seen in FIG. 3, when the content type setting in the GUI changes from Automatic (indicating that a smart copy is to be performed that will determine content type) to any other content type selection (indicating a non-smart copy is to be performed), the scan bar is moved immediately to the top of the page scan location (Home Position state 301) even before a user presses a Start Copy button, as shown by arrow 304. Moving the scan bar to the non-smart copy home position immediately upon the content type menu selection change saves time in the actual copy operation by eliminating the penalty of waiting for the scan bar to be positioned prior to scan start.

The state diagram 301 illustrates how the method and system of the present disclosure can also operate when the content type setting is changed from anything other than Automatic to Automatic (indicating a change to smart copy). The scan bar would then move automatically to the Pre-scan Position state 302 as soon as the user makes the change on the GUI as shown by arrows 305 and 306. This would occur prior to the user actually selecting the start of a copy in an effort to eliminate time delays for the Pre-scan Position move. As shown by arrow 305 when the content type setting changes to Automatic the scan bar moves from the top of the page location (Home Position state 301) to the Pre-scan Position state (302) for smart copy. Also as shown by arrow 306 when the content type setting changes to Automatic (without an ADF sensor trip) the scan bar goes from the ADF Scan Position 303 to the bottom of the page in the Pre-scan Position state 302 for smart copy.

A further refinement when the content type setting changes from Automatic to other than Automatic (arrow 304) and when the content type setting changes from other than Automatic to Automatic (arrows 305 and 306) is implementing an optimized scan bar reposition move speed. An example would be scan bar reposition speed dependent on copy quality where for a draft copy, move the scan bar to top of the page at the highest motor speed, and otherwise move it to the top of the page at a lower motor speed. This will reduce the system acoustic noise (especially in systems with a stepper motor) when performing normal copies.

Other non-smart copy situations addressed by the present disclosure include when an ADF paper input sensor is tripped the scan bar should move to an ADF Scan Position (sometimes this is an ADF scan calibration strip position) in preparation for an ADF copy or scan (see arrows 307 and 308).

In addition, if the user enters the Fax menu and begins to make Fax settings the scan bar should be re-positioned for a fax submission. Though the optimal reposition is typically to the ADF Scan Position for faxing, the machine might instead move the scan bar to the Home Position in anticipation of either a flatbed or ADF fax operation, as shown by arrow 304.

Since scans to a host PC would not use any smart copy aspects, for user entry into any host-scan-related GUI/TUI menu the scan bar position should be changed immediately to reflect the impending Scan to Host function. As shown by arrow 304 if a user enters the Scan to Host GUI that will also trigger a state change from Pre-scan Position state 302 to Home Position state 301 so that the scan bar is moved from a bottom of the page position to a top of the page position

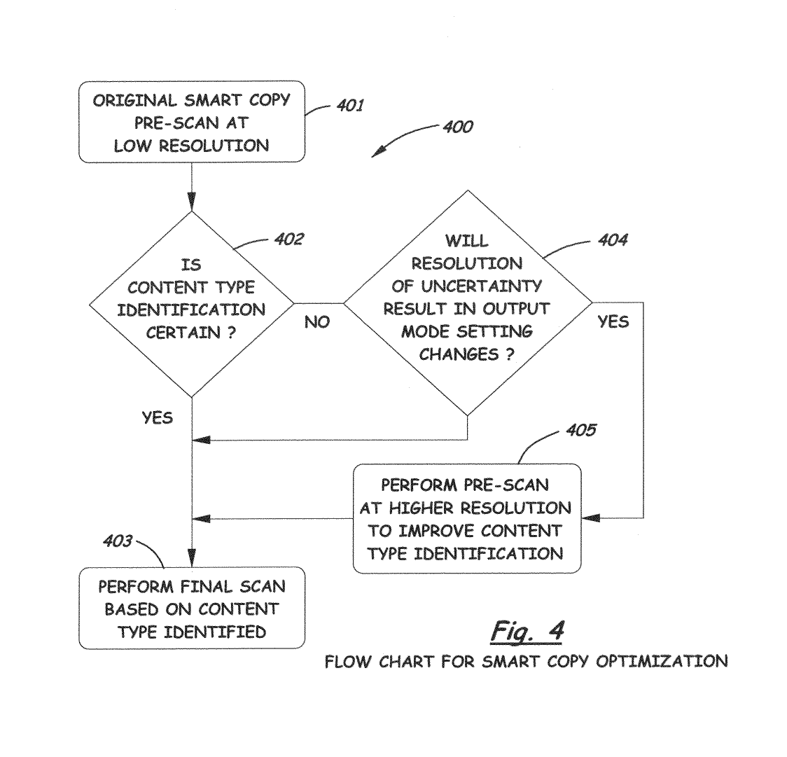

FIG. 4 of the drawings illustrates another enhancement of the present disclosure. This enhancement addresses the defects in scanned copies due to misidentification of the original content type. Misidentification (as defined earlier) mainly occurs because of the low resolution pre-scan. Higher resolution pre-scans more accurately determine the content type but take additional time. The present disclosure provides for implementing a second pre-scan at a higher resolution to determine content type when the initial pre-scan is not able to accurately distinguish between two or more possible content types.

For example if the original content type was determined with confidence, the final scan and smart copy is performed in the traditional method. However, if the original's content type was unable to be clearly determined, then a second pre-scan at a higher resolution is invoked to accurately determine the original's content type.

In addition, a further refinement of this enhancement is that the second pre-scan should only occur if the original was unable to be determined between two content types that make a difference. A second pre-scan is not performed if it is determined that the content type is one of two or more content types such that selecting either of the two content types over the other does not make a significant improvement in the copy.

A matrix could be used to determine when a second pre-scan is invoked depending on the possible content types of the original.

Thus in the method and system 400 shown in FIG. 4 the first step 401 is to perform a smart copy pre-scan of the original document at a low resolution. A determination is then made as to whether the content type identification is certain at step 402. If identification is certain then the final scan based on the content type identified is performed as indicated in step 403. If the content type is not clearly identified then a determination is made as to whether resolving the uncertainty results in the output mode settings being changed in step 404. For instance, it the content had been narrowed down to being either color or mono text (though some uncertainty still may exist as to which of these two it is), although these two content types differ, the mode settings of the final scan would not change the output quality enough to warrant the time spent for performing a second higher resolution pre-scan. In other situations, where warranted, the second pre-scan at a higher resolution would be performed as shown in step 405. Then the final scan would be performed in Step 403. For example, if an original contains both mixed Text and Mono Gray-scale images and the function narrowed the content to either Mono Text or Mixed Graphics, a second prescan could determine the exact content and the resulting output would be printed such that the gray scale is more visible and not washed out, had the function determined it was Mono Text.

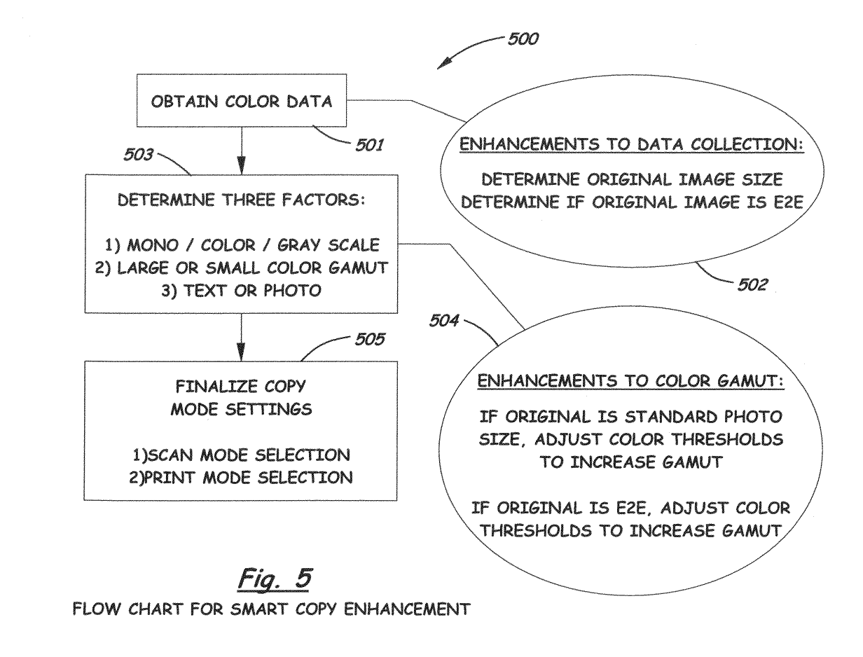

A third enhancement of the present disclosure improves content type detection through the use of original (document to be scanned) attributes that are in addition to the data used currently by the prior art smart copy function. Currently only the color data collected during the pre-scan is used to determine content type. Illustrating the enhancement of the present disclosure in FIG. 5, the original document's detected size and whether it is printed edge to edge (E2E) is used in assisting the determination of content type. Thus the method and system 500 of the present disclosure first considers not only color data (step 501) but also adds the enhancement of determining the original document's image size and determining if the original document's image content is edge to edge (E2E) (step 502). The output paper size and whether it is E2E are also factors that are employed by the method and the system of the present disclosure in determining the content of the original document.

An original's size may be determined in many ways. Typically these involve determining the extent of the area of a scan for which pixels generally differ from a known background pixel color value. For instance, if the backer or foam press plate on the scanner lid is black, an original document's size can be determined by examining the extent of the field of pixel values in the pre-scan that are not black. This field will generally include the entire media expanse, not just the image expanse on the media. This can be similarly determined with white and other color backers, luminescent backers, etc. other methods exist as well, and the invention is not limited to any one particular method.

Similarly, whether an original contains an E2E image may also be determined in similar ways. Typically these involve first determining the original's media expanse as described above In addition, the original's image expanse is also determined as the expanse over which relatively non-white/non-black pixels exist in the pre-scan image. If the entire media expanse equals the image expanse on the media, the media expanse is determined to be E2E. Otherwise, it is not considered to be E2E. Again, this can be similarly determined with white and other color backers, luminescent backers, etc. Other methods exist as well; the invention herein is not to be limited to any one particular method.

The size of the original document and the E2E properties are employed as either overriding or contributing factors in determining the content of the original document when analyzed along with other traditional color properties.

As an example of use of the size and E2E properties, a problem exists with photo originals having a large gamut but which appear to the smart copy function to have a small gamut due to the original's content being focused within a specific color region. Thus, a picture of a yellow object with a yellow background would likely be erroneously detected as a small gamut original and the resulting smart copy would be sub-optimal (washed-out looking). This enhancement of the present disclosure remedies this, enhancing the smart copy content detection by taking into account if the original was detected as a typical photo size (4×6 in., 5×7 in., 8×10 in., wallet, etc.) or printed E2E, so the gamut is determined as large instead of as small. The result is a better quality copy because the gamut is determined correctly using the enhancement of this present disclosure.

Thus when size or E2E properties of an original document are a factor for smart copy content detection the following is performed:

1. When the pre-scan identifies the original document is a typical photo size, the original is assumed to be a large gamut (see step 504 enhancement for step 503 in FIG. 5).

2. Photo originals are very often E2E, and thus when the pre-scan identifies the image on the original as having this attribute, it is assumed that the original document has a large gamut (see step 504—enhancement for step 503 in FIG. 5).

3. Variable large/small gamut thresholds are used, e.g. the gamut threshold is changed based on size and E2E properties in determining the content along with the color data (see step 504 of FIG. 5). Thus, for example, adjustment of the small/large gamut histogram threshold would be more likely determined to be a large gamut for a photo or an E2E original. Moving the gamut threshold cutoff towards small would be preferable if the original document is determined to be a typical non-photo size such as Letter size, A4 size or a non E2E print. Similarly the output (target) paper size or type could be used to skew the determination, i.e. typical photo size output could skew the determination of the original to a large gamut.

Thus as shown in FIG. 5, the color data is obtained (step 501), the color data set is enhanced by step 502 where determinations, as discussed previously, are made as to size and E2E.

In step 503 three factors are considered: 1) mono/color/gray scale; 2) large or small color gamut; and 3) text or photo. This step 503 is enhanced as described above by step 504 to determine if the original is a photo size in which case the color threshold is increased to a large gamut and if the original is E2E the color gamut would also be increased to large gamut. Finally in step 505 the copy mode settings are finalized with a scan mode selection and a print mode selection.

The foregoing description of several embodiments of the present disclosure has been presented for purposes of illustration. It is not intended to be exhaustive or to limit the invention to the precise forms described, and obviously many modifications and variations are possible in light of the above teaching. It is intended that the scope of the invention be defined by the claims appended hereto.

What is claimed is:

1. A method for enhancing a smart copy function for scanning a document, comprising:
examining a content type setting for a document to be scanned for determining if the content type setting is changed to an automatic mode for scanning the document or to anything other than the automatic mode; and
moving a scan bar of a scanner to one of a plurality of positions based upon the content type setting detected during examination thereof, thereby positioning said scan bar in a correct position prior to pre-scanning the document.

1. The method according to claim 1, wherein said plurality of positions include one or more of a home position where said scan bar is positioned at top of a page; a pre-scan position where said scan bar is positioned at bottom of page; and an ADF scan position.

2. The method according to claim 1, wherein if said examining determines said content type setting to be changed to the automatic mode then said scan bar is moved to a pre-scan position.

3. The method according to claim 1, wherein if said examining determines said content type setting is changed to other than the automatic mode then said scan bar is moved from a pre-scan position to another position.

4. The method according to claim 1, wherein if during said examining it is determined that at least one of an ADF paper input sensor being tripped, and a user interface being in a Fax menu or an ADF scan menu, then said scan bar is positioned at an ADF scan position.

5. The method according to claim 1, wherein if said examining determines a user entered a scan to host UI then the scan bar is changed from a pre-scan position to another position.

6. A method for enhancing a smart copy function for scanning a document, comprising:
performing a first pre-scan on a document at a low resolution;
determining whether to perform a second pre-scan at a higher resolution based upon the first pre-scan;
selectively performing the second pre-scan on the document based upon the determination;
setting a resolution for the final scan; and
performing a final scan on the document using the set resolution.

7. The method of claim 7, wherein the determining comprises determining whether a content type of the document is uncertain based upon the first pre-scan.

8. The method of claim 7, wherein the second pre-scan is performed if content type of the document is determined to be one of at least two content types and output mode settings will change if content type is determined to be a particular one of the at least two content types.

9. A method for scanning a document, comprising:
determining, during a pre-scan operation of a document, at least one of a size of the document and whether the document includes edge-to-edge imaging;
identifying a color gamut setting for the document based upon the determination; and
performing a final scan of the document using the identified color gamut setting.

10. The method according to claim 10, wherein identifying the color gamut setting comprises increasing the color gamut setting upon an affirmative determination that the size of the document corresponds to a size of a standard photograph. The method according to claim 10, wherein identifying the color gamut setting comprises increasing the color gamut setting upon an affirmative determination that the document includes an edge-to-edge image.

11. A method of scanning a document, comprising:
performing a pre-scan of a document in a first direction;
during the pre-scan, determining a content type of the document to be one of a plurality of content types;
determining a direction to initiate a final scan of the document based upon the content type; and
performing the final scan of the document in the determined direction.

12. The method of claim 13, wherein determining the direction of the final scan comprises determining a present location of the scan bar during the pre-scan.

13. The method of claim 13, wherein the direction of the final scan is determined to be the first direction if a resolution level of the pre-scan substantially matches a resolution level corresponding to the determined content type, wherein the final scan continues the pre-scan of the document from a location of the scan bar during the pre-scan.

14. The method of claim 13, wherein the direction of the final scan is determined to be the first direction if a resolution level of the pre-scan does not substantially match a resolution level corresponding to the determined content type and if a completion percentage of the pre-scan is less than a predetermined percentage value.
